(19) United States
(12) Patent Application Publication
(10) Pub. No.: US 2012/0209659 A1
(43) Pub. Date: Aug. 16, 2012

(54) COUPLING DEMAND FORECASTING AND PRODUCTION PLANNING WITH CHOLESKY DECOMPOSITION AND JACOBIAN LINEARIZATION

(75) Inventor: Georges-Henri Moll, Villeneuve-Loublet (FR)

(73) Assignee: International Business Machines Corporation, Armonk, NY (US)

(21) Appl. No.: 13/025,820

(22) Filed: Feb. 11, 2011

(51) Int. Cl. G06Q 10/00

(52) U.S. Cl. 705/7.31

(57) ABSTRACT

A method, system and computer program product for coupling forecasting and planning in a production planning tool is provided. In an embodiment of the invention, a method for coupling forecasting and planning in a production planning tool is provided. The method includes invoking a forecasting module in a production planning tool executing in memory of a computer upon demand data to compute a forecasting model. The method also includes retrieving a stochastic vector from the computed forecasting model for a product, the stochastic vector expressing vector of expected values of demand for the product, and linearizing the stochastic vector in a matrix describing a linear model for demand of the product. The method further includes providing the linearized stochastic vector to a stochastic linear program (LP) relaxation of a planning module of the production planning tool.

### BACKGROUND OF THE INVENTION

1. Field of the Invention

The present invention relates to production planning pattern management and more particularly to coupling demand forecasting and production planning in a production planning tool.

2. Description of the Related Art

As illustrated in FIG. 1, the classical production planning pattern consists in having a sequence of modules, namely forecasting 110, planning 120, scheduling 140 and transportation 150. The heuristic part 130 of planning is necessary for accounting for non linear requirements of planning (constraints and objectives), that the LP relaxation 125 ignores. The planning heuristic 130, however, is at the same granularity (time, products, and resources) as the LP relaxation 125, as opposed to detailed scheduling, which is by definition at the more detailed level of granularity.

The classical way of coupling forecasting and production planning consists in matching a stochastic module (where the output data are random variables, not constants), and a deterministic module (classical planning is traditionally deterministic). The classical way of using forecast data for planning consists in using only the expected values of forecasts as input to subsequent modules. This is a very straightforward (and rather violent) way of separating the stochastic world and the deterministic world.

The problem with early separation of the stochastic side and the deterministic side (see stochastic frontier 160), is that a demand D1 of expected value d, and standard deviation s1, is treated equally with demand D2 with E(D2)=d and s(D2)=s2, so that even if s1 is very small compared to s2 (s1<<s2), the precision on D1 is much greater than the precision on D2, so it does not make much sense to try to satisfy D2 to the degree that we try to satisfy D1.

### BRIEF SUMMARY OF THE INVENTION

Embodiments of the present invention address deficiencies of the art in respect to production planning and provide a novel and non-obvious method, system and computer program product for coupling forecasting and planning in a production planning tool. In an embodiment of the invention, a method for coupling forecasting and planning in a production planning tool is provided. The method includes invoking a forecasting module in a production planning tool executing in memory of a computer upon demand data to compute a forecasting model. The method also includes retrieving a stochastic vector from the computed forecasting model for a product, the stochastic vector expressing vector of expected values of demand for the product, and linearizing the stochastic vector in a matrix describing a linear model for demand of the product. The method further includes providing the linearized stochastic vector to a stochastic linear program (LP) relaxation of a planning module of the production planning tool.

In one aspect of the embodiment, linearizing the stochastic vector in a matrix includes linearizing the stochastic vector in a Jacobian matrix H, such that D=HV+m where D is the stochastic vector and v is a vector of independent normalized random variables. In another aspect of the embodiment, the method includes estimating a covariance matrix together with the stochastic vector from past data in the forecasting model and deducing the matrix utilizing Cholesky decomposition.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a classical production planning pattern;

FIG. 2 is a pictorial illustration of a production planning pattern with coupling of forecasting and planning in a production planning tool;

FIG. 3 is a schematic illustration of a data processing system configured for coupling forecasting and planning in a production planning tool; and

FIG. 4 is a flow chart illustrating a process for coupling forecasting and planning in a production planning tool.

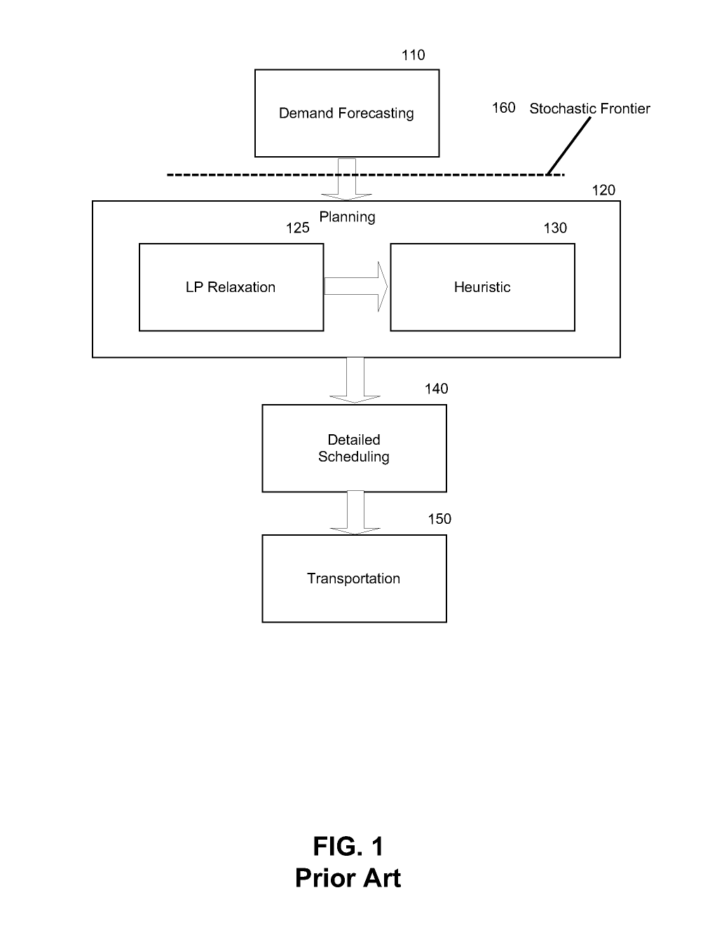

### DETAILED DESCRIPTION OF THE INVENTION

Embodiments of the invention provide for a method, data processing system and computer program product for coupling forecasting and planning in a production planning tool. In accordance with an embodiment of the invention, a forecasting module in a production planning tool of an operating system executing in memory of a computer can be invoked upon demand data to compute a forecasting model. A stochastic vector from the computed forecasting model for a product can be retrieved. The stochastic vector can be linearized in a matrix that describes a linear model for demand of the product. Subsequently, the linearized stochastic vector can be provided to a stochastic linear programming (LP) relaxation of a planning module of the production planning tool.

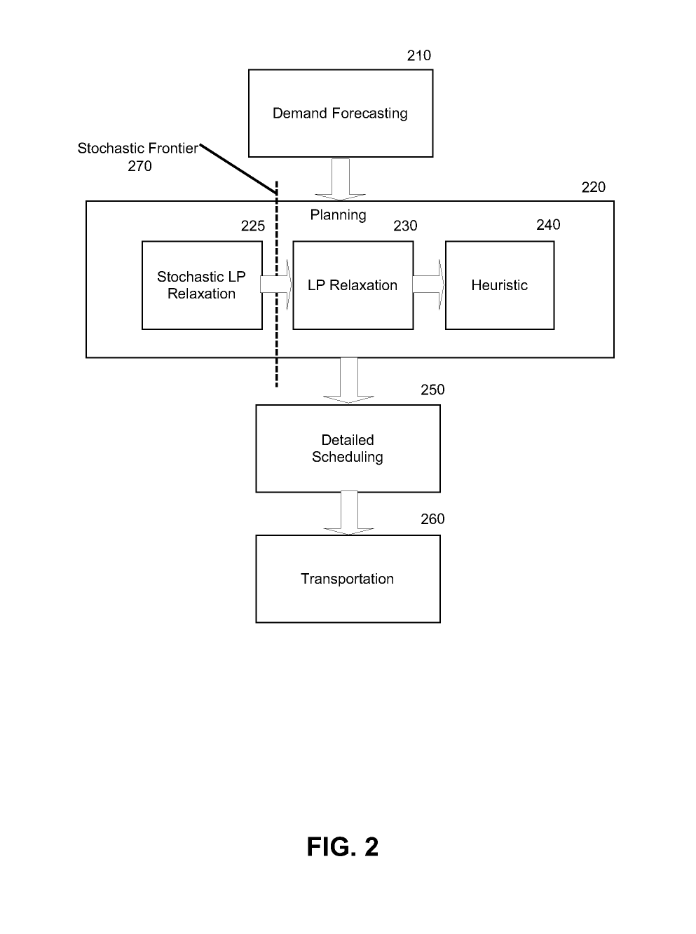

In further illustration, FIG. 2 pictorially depicts a process for coupling forecasting and planning in a production planning tool. As shown in FIG. 2, production planning pattern consists in having a sequence of modules, namely forecasting 210, planning 220, scheduling 250 and transportation 260. In this framework, the output of the stochastic LP relaxation 225 is deterministic production decisions under resource constraint that maximizes the expected value of the gain. Moreover, the stochastic LP model is at the proper time/product/resource granularity in order to fit the technologic limits. Thus as illustrated in FIG. 2, the stochastic frontier 270 of the planning pattern is advanced by adding a stochastic LP relaxation module 225 to the planning module 220. In this sense, a stochastic LP pre-processing phase 225 is added to the classic LP+scheduling heuristic (230 and 240). The issue to resolve is how to fit the output of forecasting module 210 into the input of the stochastic LP module 225.

Demand forecasting is based on models of the form:

D_{p,t+1}=ƒ_{θ}_{₁}_{, . . . ,θ}_{ₖ}(D_{p,t},D_{p,t-1} . . . D_{p,t-n} . . . ,D_{p′,t}, . . . ,D_{p′,t-n},Vₜ₊₁)+εₜ.

(p is a product index, while t is the time index. D means “demand”)

D_{p,t}, D_{p,t-1} . . . D_{p,t-n} is the endogenous part, while vector Vₜ₊₁ is the exogenous part.

The output from forecasting is function ƒ_{θ}_{₁}_{, . . . ,θ}_{ₙ}.

An avatar of ƒ_{θ}_{₁}_{, . . . ,θ}_{ₙ} is g_{θ}_{₁}_{, . . . ,θ}_{ₖ}

An avatar of g_{θ}_{₁}_{, . . . ,θ}_{ₖ} is matrix {E(D), cov(D)}, where coy is the covariance matrix of D, and E(D) is the vector of expected values of D. {E(D), cov(D)}which has less information than g_{θ}_{₁}_{, . . . ,θ}_{ₖ}, but still is a 2^{nd} moment estimation of D. E(D) is the 1^{st} moment only approximation of D, and alone it is a serious loss of information about D.

{E(D), s(D)}, where s(D) is the vector of standard deviation of D (a.k.a the diagonal of cov(D)), is an approximation of D ignoring time/product dependencies, and is a serious loss of information from D.

{E(D), [min(D),max(D)]} where [min(D),max(D)] is a confidence interval for D for a given risk (typically 5%), is less informed than {E(D), s(D)}. Thus, E(D) alone is an almost complete loss of information from D.

Matching the forecasting output and stochastic LP input is a important consideration. So, the coupling question can be rephrased as: how to transform ƒ_{θ}_{₁}_{, . . . ,θ}_{ₙ} into either:

1. an explicit set of scenarios D(w1), . . . D(wn) (D for demands) with their probabilities p1, . . . , pn, or

2. into a form close to D=HV, where H is a constant matrix and V a vector of independent random variables with known distributions.

One way is to directly use the forecasting model for sampling by trying to transform g_{θ}_{₁}_{, . . . ,θ}_{ₙ} into an explicit set of scenarios D(w1), . . . D(wn) (D for demands) with their probabilities p1, . . . , pn. An easier route is to use g, more precisely model D=g_{θ}_{₁}_{, . . . ,θ}_{ₖ}(d, ε). By randomly sampling white noise ε, to obtain D(ωᵢ)=g_{θ}_{₁}_{, . . . ,θ}_{ₖ}(d, ε(ω)).

A second way is to linearize the forecasting model by linearizing equation D=g_{θ}_{₁}_{, . . . ,θ}_{ₖ}(d, ε) in order to get something close to D=HV.

Applying the Jacobian matrix of g_{θ}_{₁}_{, . . . ,θ}_{ₙ}

$${H}_{( p , t ) , {t}^{′}} = \frac{\partial {g}_{p , t}}{\partial {ɛ}_{t}} ( 0 )$$

Results in the linear approximation H of g at (central) point 0.

D=H·εₜ+g_{θ}_{₁}_{, . . . ,θ}_{ₙ}(d,0)

Which in turn can be input directly to the importance sampling phase of stochastic LP algorithm or this equation can be used directly by the stochastic LP by replacing:

$$\begin{matrix}\{ \begin{matrix}min Z = cx + E ( {qy}^{ω} ) \\ Ax = b \\ - {B}^{ω} x + {Wy}^{ω} = {h}^{ω} \\ x , {y}^{ω} \geq 0\end{matrix} & by \{ \begin{matrix}min Z = cx + E ( {qy}^{ω} ) \\ Ax = b \\ - {B}^{ω} x + {Wy}^{ω} - {z}^{ω} = 0 \\ {z}^{ω} - H . {v}^{ω} = {g}_{{θ}_{1} , … , {θ}_{n}} ( d , 0 ) \\ x , {y}^{ω} , {z}^{ω} \geq 0\end{matrix} \\ \begin{matrix}\begin{matrix}Note \text{:} If only the demand is \\ stochastic , then B is\end{matrix} \\ deterministic , and D = h\end{matrix} & \begin{matrix}\begin{matrix}where z is an stage 2 variable , and v \\ is our new vector of independent\end{matrix} \\ random variables\end{matrix}\end{matrix}$$

A third way is to use a simple covariance forecasting model, where the forecasting model outputs a covariance matrix of D, together with expected values that is {E(D),cov(D)} by implementing the calculation of H, as a function of covariance matrix cov(D). The relationship between H and cov(D) is given as:

Let D=H·V+d where d=E(D)

Then

cov(D)=E(D−E(D)·(D−E(D))^{t})=E((HV)·(HV)^{t})=(HVV^{t}H^{t})=HE(VV^{t})H^{t}=HH^{t}

cov(D)=E(D−E(D)·(D−E(D))^{t}) can be estimated by using past data under the (pseudo-stationary) hypothesis: ∀t≦0, ∀n, cov(D_{p,t}, D_{p′,t′})=cov(D_{p,t+n}, D_{p′,t′+n})

Using f to infer null co-variances

$$\frac{\partial {f}_{pt}}{\partial {D}_{{p}^{′} {t}^{′}}} = 0 ⇒ cov ( {D}_{pt} , {D}_{{p}^{′} {t}^{′}} ) = 0$$

The right algorithm to inverse equation cov(D)=HH^{T}, that is calculate H as a function of D: H=H(D). This is Cholesky decomposition. The calculated H matrix can be input to the stochastic LP algorithm (phase 1: i.e., sampling) or equivalently by replacing the LP model by:

$$\begin{matrix}\{ \begin{matrix}min Z = cx + E ( {fy}^{ω} ) \\ Ax = b \\ - {B}^{ω} x + {Wy}^{ω} = {h}^{ω} \\ x , {y}^{ω} \geq 0\end{matrix} & by \{ \begin{matrix}min Z = cx + E ( {fy}^{ω} ) \\ Ax = b \\ - {B}^{ω} x + {Wy}^{ω} - {z}^{ω} = 0 \\ {z}^{ω} - H . {v}^{ω} = E ( D ) \\ x , {y}^{ω} , {z}^{ω} \geq 0\end{matrix} \\ \begin{matrix}\begin{matrix}Note \text{:} If only the demand \\ is stochastic , then B is\end{matrix} \\ deterministic , and D = h\end{matrix} & \begin{matrix}\begin{matrix}( where z is an stage 2 variable , and \\ v is our new vector or independent\end{matrix} \\ variables )\end{matrix}\end{matrix}$$

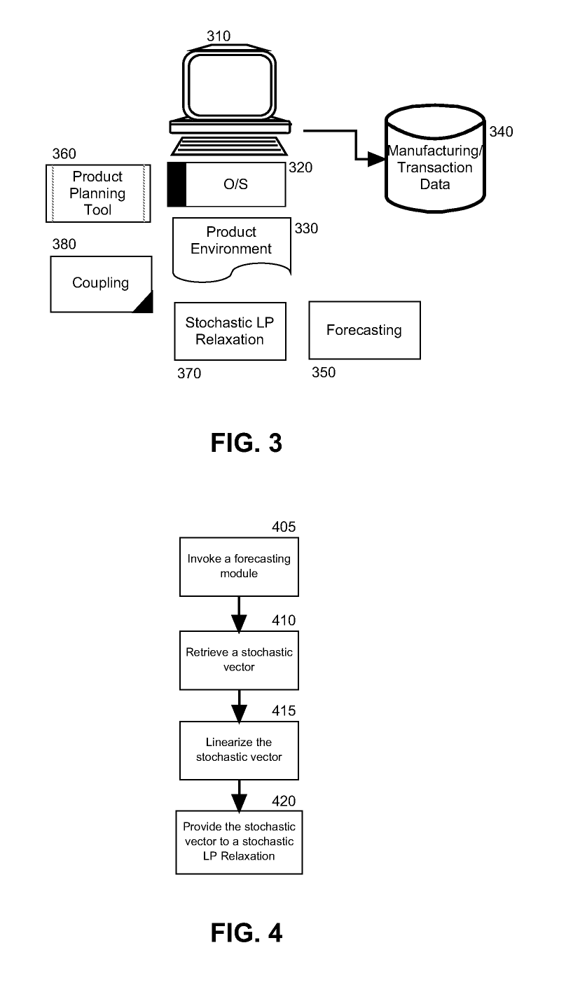

The process described in connection with FIG. 2 can be implemented in a data processing system. In this regard, FIG. 3 is a schematic illustration of a data processing system configured for coupling forecasting and planning in a production planning tool. The system can include a computer 310 with at least one processor and memory. The computer 310 can include an operating system 320 executing in the memory by at least one of the processors and can provide a product planning environment 330. The product planning environment 330 can include different applications and product planning modules, e.g., forecasting module 350 and stochastic LP relaxation module 370.

A coupling manager 380 can be coupled to the operating system 320 along with a product planning tool 360. The coupling manager 380 can be enabled to respond to the implementation of the stochastic LP relaxation module 370 with the forecasting module 350 to couple the output of the forecasting module 350 to the input of the stochastic LP relaxation module 370. In embodiments, the stochastic LP relaxation module 370, the forecasting module 350 and coupling manager 380 could all be integrated into a single module, e.g., product planning tool 360, in several modules or remain independent.

In even yet further illustration of the operation of the coupling manager 380, FIG. 4 is a flow chart illustrating a process for coupling forecasting and planning in a production planning tool. Beginning in block 405 of FIG. 4, a forecasting module in a production planning tool executing in memory of a computer upon demand data to compute a forecasting model can be invoke for the product environment. In block 410, a stochastic vector can be retrieved from the computed forecasting model for a product where the stochastic vector expresses a vector of expected values of demand for the product. In block 415, a stochastic vector can be linearized in a matrix describing a linear model for demand of the product and in block 420, the linearized stochastic vector can be provided to a stochastic linear program (LP) relaxation of a planning module of the production planning tool. In embodiments, the linearization of the stochastic vector in a matrix comprises linearizing the stochastic vector in a Jacobian matrix H, such that D=HV+m where D is the stochastic vector and v is a vector of independent normalized random variables. In other embodiments, the process further can include estimating a co-variance matrix together with the stochastic vector from past data in the forecasting model and deducing the matrix utilizing Cholesky decomposition.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for coupling forecasting and planning in a production planning tool, the method comprising:
invoking a forecasting module in a production planning tool executing in memory of a computer upon demand data to compute a forecasting model;
retrieving a stochastic vector from the computed forecasting model for a product, the stochastic vector expressing a vector of expected values of demand for the product;
linearizing the stochastic vector in a matrix describing a linear model for demand of the product; and,
providing the linearized stochastic vector to a stochastic linear programming (LP) relaxation of a planning module of the production planning tool.

2. The method of claim 1, wherein linearizing the stochastic vector in a matrix comprises linearizing the stochastic vector in a Jacobian matrix H, such that D=HV+m where D is the stochastic vector and v is a vector of independent normalized random variables.

3. The method of claim 1, further comprising:
estimating a co-variance matrix together with the stochastic vector from past data in the forecasting model; and,
deducing the matrix utilizing Cholesky decomposition.

4. A data processing system configured for coupling forecasting and planning in a production planning tool, the system comprising:
a computer with at least one processor and memory;
a product environment loaded in the memory of the computer and rendered in a display of the computer;
an product planning tool executing in the computer; and,
a coupling manager executing in the memory of the computer, the coupling manager comprising program code enabled to invoke a forecasting module in a production planning tool executing in memory of a computer upon demand data to compute a forecasting model, to retrieve a stochastic vector from the computed forecasting model for a product, the stochastic vector expressing a vector of expected values of demand for the product to linearize the stochastic vector in a matrix describing a linear model for demand of the product and provide the linearized stochastic vector to a stochastic linear programming (LP) relaxation of a planning module of the production planning tool.

5. A computer program product for comprising:
a computer readable storage medium having computer readable program code embodied therewith, the computer readable program comprising:
computer readable program code for invoking a forecasting module in a production planning tool executing in memory of a computer upon demand data to compute a forecasting model; computer readable program code for retrieving a stochastic vector from the computed forecasting model for a product, the stochastic vector expressing a vector of expected values of demand for the product;
computer readable program code for linearizing the stochastic vector in a matrix describing a linear model for demand of the product; and,
computer readable program code for providing the linearized stochastic vector to a stochastic linear programming (LP) relaxation of a planning module of the production planning tool.

6. The computer program product of claim 5, wherein the computer readable program code for linearizing the stochastic vector in a matrix comprises computer readable program code for comprises computer readable program code for linearizing the stochastic vector in a Jacobian matrix H, such that D=HV+m where D is the stochastic vector and v is a vector of independent normalized random variables,

7. The computer program product of claim 5, further comprising:
computer readable program code for estimating a co-variance matrix together with the stochastic vector from past data in the forecasting model; and,
computer readable program code for deducing the matrix utilizing Cholesky decomposition.
